(19) United States
(12) Patent Application Publication
(10) Pub. No.: US 2011/0102392 A1
(43) Pub. Date: May 5, 2011

(54) DISPLAY DEVICE

(76) Inventors: Akizumi Fujioka, Osaka (JP); Toshihiro Yanagi, Osaka (JP)

(21) Appl. No.: 13/001,053

(22) PCT Filed: May 13, 2009
(86) PCT No.: PCT/JP2009/058916

§ 371 Date: Dec. 23, 2010

(30) Foreign Application Priority Data
Jul. 1, 2008 (JP) 2008-172744

(51) Int. Cl. G09G 3/36; G09G 5/10

(52) U.S. Cl. 345/207; 345/102

(57) ABSTRACT

A liquid crystal display device (10) is a liquid crystal display device (10) having a function of sensing an image of an image sensing object, the liquid crystal display device (10) comprising: a liquid crystal panel (11) which transmits light that has entered the liquid crystal panel (11) and which has a transmittance variable for the light; a backlight device (15) which emits, to the liquid crystal panel (11), both visible light and non-visible light; and an optical sensor (2) which is provided in the liquid crystal panel (11) and which receives at least infrared light (non-visible light) that enters the liquid crystal panel (11), the liquid crystal display device (10) adjusting a ratio between the visible light and the non-visible light, both of which are emitted to an image sensing object, so as to sense an image of the image sensing object with use of at least the non-visible light. The liquid crystal display device (10) can thus (i) simultaneously achieve a display function and an image sensing function and (ii) sense an image with use of at least non-visible light.

### TECHNICAL FIELD

The present invention relates to a display device which has a function of sensing an image of an image sensing object with use of at least non-visible light.

### BACKGROUND ART

Growing awareness about security has conventionally led to implementation of a measure of printing, on a valuable printed material (for example, a bank note and a securities certificate), not only a visible image but also an invisible image which is perceivable only when irradiated with non-visible light.

For example, a visible light image is printed on a printed material with an ink which reflects visible light, and an infrared light image is further printed on the printed material with an ink which reflects infrared light. The human eye can, when seeing such a printed material, perceive the visible light image, but cannot perceive the infrared light image. Such a hidden infrared light image is perceivable only when sensed with use of infrared light. Thus, even in a case where the human eye cannot reliably determine whether such a printed material is a counterfeit one, it is possible to reliably determine it by emitting infrared light to the printed material and thus determining whether an infrared light image is visible on the printed material.

An example printed material of this kind is disclosed in Patent Literature 1.

Further, various devices have been developed which read both a visible image and an invisible image printed on a single printed material. An example of such devices is disclosed in Patent Literature 2. An image reading device of Patent Literature 2 includes (i) a first reading section which reads a document image formed on a surface of a printed material, and (ii) a second reading section which reads a code image, formed on the surface on which the document image is formed, when the first reading section reads the document image.

With this arrangement, the image reading device of Patent Literature 2 can (i) emit visible light to the printed material so as to cause a visible light sensor to read a reflection from the printed material, and (ii) emit infrared light to the printed material so as to cause an infrared light sensor to read a reflection from the printed material. It follows that the image reading device can, (i) when emitting visible light, read the document image as seen by the human eye, and (ii) when emitting infrared light, read the invisible code image.

### CITATION LIST

### Patent Literature 1

Japanese Patent Application Publication, Tokukai, No. 2007-136338 A (Publication Date: Jun. 7, 2007)

### Patent Literature 2

Japanese Patent Application Publication, Tokukai, No. 2007-306047 A (Publication Date: Nov. 22, 2007)

### SUMMARY OF INVENTION

The image reading device of Patent Literature 2, however, cannot simultaneously have a display function and an image sensing function. In other words, the image reading device requires a display screen separately from an image sensing surface.

The present invention has been accomplished in view of the above problem. It is an object of the present invention to provide a display device which can (i) simultaneously achieve a display function and an image sensing function and (ii) sense at least a non-visible light image.

In order to solve the above problem, a display device of the present invention is a display device having a function of sensing an image of an image sensing object, the display device including: a display panel which transmits light that has entered the display panel and which has a transmittance variable for the light; a light source which emits, to the display panel, light including visible light and non-visible light; and an optical sensor which is provided in the display panel and which receives at least non-visible light that enters the display panel, the display device adjusting a ratio between the visible light and the non-visible light, both of which are emitted to an image sensing object, so as to sense an image of the image sensing object with use of at least the non-visible light.

According to the above arrangement, the display device (i) causes the light source to emit light so that the light is transmitted through the display panel to reach an image sensing object, and (ii) causes the optical sensor to receive a reflection from the image sensing object. The display device thus senses an image of the image sensing object so as to obtain the image. The light source emits light including visible light and non-visible light (for example, infrared light). Such visible light and non-visible light are each transmitted through the display panel at a transmittance corresponding to a display state of the display panel, and travel toward the image sensing object. The optical sensor is provided in the display panel, and receives at least non-visible light reflected from the image sensing object. In other words, the display device can read an image of the image sensing object on a display surface of the display panel.

As described above, the display device can (i) simultaneously achieve a display function and an image sensing function and (ii) sense at least a non-visible light image.

The display device of the present invention may preferably further include: an irradiation light control section which controls the ratio by changing a display state of the display panel.

According to the above arrangement, the display device controls the ratio between the visible light and the non-visible light, both emitted to the image sensing object, by changing the display state of the display panel. In a case where, for example, a white image is displayed on the display panel, both visible light and non-visible light are emitted to the image sensing object. On the other hand, in a case where a black image is displayed on the display panel, non-visible light is emitted to the image sensing object.

Thus, in a case where an image sensing object is provided with a decoration (for example, a print) which has (i) a low reflectance for visible light and (ii) a high reflectance for non-visible light, the display device can selectively obtain, when sensing an image of a single image sensing object, a visible light image (visible image) and a non-visible light image (invisible image) from the image sensing object by controlling a light transmittance of the display panel. The light transmittance of the display panel can be flexibly changed by changing a property (for example, a color and a pattern) of an image to be displayed on the display panel. Further, by partially changing a display state of the display panel, it is possible to, for example, emit non-visible light from only a part of the display panel toward the image sensing object.

As described above, the display device can sense a non-visible light image with use of only a part of an image sensing surface.

The display device of the present invention may preferably further include: an image sensing processing section which causes the optical sensor to sense the image of the image sensing object while causing the display panel to display a predetermined image.

According to the above arrangement, the display device displays a predetermined image on the display panel to control the light transmittance of the display panel. The display device displays, for example, (i) a white image to transmit both visible light and non-visible light, or (ii) a black image to transmit only non-visible light. This arrangement allows the display device to selectively obtain a visible light image or a non-visible light image of the image sensing object.

The display device of the present invention may preferably be arranged such that the image sensing processing section causes the optical sensor to sense the image of the image sensing object while causing the display panel to display a low-luminance image. Further, the low-luminance image is preferably a black image.

According to the above arrangement, the display panel, while displaying a low-luminance image (for example, an image having an average luminance of 50% or lower relative to a luminance of 100% for a white image), has (i) a low transmittance for visible light and (ii) a sufficiently high transmittance for non-visible light such as infrared light. The display device thus can selectively obtain a non-visible light image of the image sensing object by sensing an image of the image sensing object in the above display state. In particular, in a case where the low-luminance image is a black image, a non-visible light image to be obtained has a maximized sharpness since the transmittance for visible light is almost 0%.

The display device of the present invention may preferably further include: the image sensing processing section causes the optical sensor to sense the image of the image sensing object while causing the display panel to display a high-luminance image. Further, the high-luminance image is preferably a white image.

According to the above arrangement, the display panel, while displaying a high-luminance image (for example, an image having an average luminance exceeding 50% relative to a luminance of 100% for a white image), has a sufficiently high transmittance for both visible light and non-visible light. The display device thus can selectively obtain a visible light image of the image sensing object by sensing an image of the image sensing object in the above display state. In particular, in a case where the high-luminance image is a white image, a visible light image to be obtained has a maximized sharpness since the transmittance for visible light is closer to 100%.

The display device of the present invention may preferably further include: a related image display section which, in a case where the image sensing processing section senses the image of the image sensing object with use of non-visible light reflected from the image sensing object, causes the display panel to display a predetermined related image corresponding to information coded in the image of the image sensing object.

According to the above arrangement, the display device senses an image of an image sensing object with use of non-visible light and obtains a visible light image. The non-visible light image includes information coded therein in the form of a bar code, for example. The coded information represents a predetermined related image. The display device thus displays, on the display panel, such a related image corresponding to the information coded in the non-visible light image read as above.

The above arrangement achieves, for instance, the following advantage: Even in a case where the display device senses an image of an image sensing object with use of visible light, and the visible light image thus obtained is out of focus, the display device (i) obtains an image, which is an in-focus equivalent of the out-of-focus visible light image, on the basis of a non-visible light image obtained by sensing the image sensing object with use of non-visible light, and (ii) displays the in-focus image on the display panel. The user in this case becomes satisfied with the displayed image without noticing the failure to sense an in-focus image of the image sensing object.

The above arrangement further achieves the following advantage: In a case where the display device merely has the function of sensing only a monochrome image, the display device (i) obtains an image which corresponds to information coded in the non-visible light image and which is a color equivalent of the monochrome image, and (ii) displays the color image. The display device in this case operates as if it has the function of sensing a color image.

The display device of the present invention may preferably further include: a guide frame display section which causes the display panel to display a predetermined guide frame in a region around a location at which the predetermined image is displayed.

According to the above arrangement, the display device displays a guide frame to instruct the user what location on the display panel the user needs to place an image sensing object close to. This increases accuracy in image sensing.

The display device of the present invention may preferably further include: a first determining section which, in a case where the image sensing processing section has sensed an image of a finger of a user with use of visible light reflected from the finger, determines whether first authentication based on the image of the finger has been successfully completed; a second determining section which, in a case where the image sensing processing section has sensed the image of the image sensing object with use of non-visible light reflected from the image sensing object, determines whether second authentication based on information coded in the image of the image sensing object has been successfully completed; and an authentication processing section which authenticates the user if (i) the first determining section has determined that the first authentication has been successfully completed and (ii) the second determining section has determined that the second authentication has been successfully completed.

According to the above arrangement, the display device can carry out both (i) first authentication based on a visible light image (for example, an image of the fingerprint of a finger) and (ii) second authentication based on a non-visible light image (for example, a bar code image). The display device thus authenticates a user only if both of the first authentication and the second authentication have been successfully completed. This significantly improves security for authentication in comparison with a case in which the display device carries out only one of the first authentication and the second authentication.

The display device of the present invention may preferably be arranged such that the light source includes (i) a visible light emitter which emits visible light and (ii) a non-visible light emitter which emits non-visible light; and the display device further includes a light emitter control section which controls light emission of the visible light emitter and light emission of the non-visible light emitter.

According to the above arrangement, the display device controls the visible light emitter and the non-visible light emitter individually. This indicates that the display device can turn on light emission of the visible light emitter and turn off light emission of the non-visible light emitter, and vice versa. This arrangement allows the display device to (i) individually adjust the kinds of light to be emitted to an image sensing object, and thus (ii) more reliably sense a visible light image and a non-visible light image individually.

The display device of the present invention may preferably be arranged such that the non-visible light is infrared light.

The display device of the present invention may preferably be arranged such that the display device is a liquid crystal display device.

As described above, the display device of the present invention includes an irradiation light control section which controls the ratio between visible light and non-visible light, both emitted to an image sensing object, by changing the display state of the display panel. The display device can thus (i) simultaneously achieve a display function and an image sensing function and (ii) sense an image with use of at least non-visible light.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a block diagram illustrating an arrangement of a liquid crystal display device in accordance with a first embodiment of the present invention.

FIG. 2 is a block diagram illustrating a detailed arrangement of a liquid crystal panel included in the liquid crystal display device illustrated in FIG. 1.

FIG. 3 is a timing chart for the liquid crystal display device illustrated in FIG. 1.

FIG. 4 is a view showing (i) a cross section of the liquid crystal panel of the liquid crystal display device illustrated in FIG. 1 and (ii) a location at which a backlight device of the liquid crystal display device is provided.

FIG. 5 is a view illustrating a first example arrangement of the backlight device of the liquid crystal display device illustrated in FIG. 1.

FIG. 6 is a view illustrating a second example arrangement of the backlight device of the liquid crystal display device illustrated in FIG. 1.

FIG. 7 is a view illustrating a third example arrangement of the backlight device of the liquid crystal display device illustrated in FIG. 1.

FIG. 8 is a view illustrating a fourth example arrangement of the backlight device of the liquid crystal display device illustrated in FIG. 1.

FIG. 9 is a view illustrating a fifth example arrangement of the backlight device of the liquid crystal display device illustrated in FIG. 1.

FIG. 10 is a cross-sectional view illustrating the backlight device of FIG. 9.

FIG. 11 is a graph showing a transmittance-spectral characteristic of the liquid crystal panel included in the liquid crystal display device illustrated in FIG. 1.

FIG. 12 is a graph showing a sensor sensitivity characteristic and a panel light-receiving sensitivity characteristic of the liquid crystal display device illustrated in FIG. 1.

FIG. 13 illustrates a specific example of image sensing by the liquid crystal display device.

FIG. 14 is a flowchart illustrating the processing of a procedure for how the liquid crystal display device senses an image of an image sensing object and displays an image obtained.

FIG. 15 is a view illustrating a state of the liquid crystal panel in which state an infrared light image sensing region has been set.

FIG. 16 is a view illustrating the liquid crystal panel on which a guide frame displayed.

FIG. 17 is a view illustrating how the liquid crystal display device illustrated in FIG. 1 carries out authentication processing.

### DESCRIPTION OF EMBODIMENTS

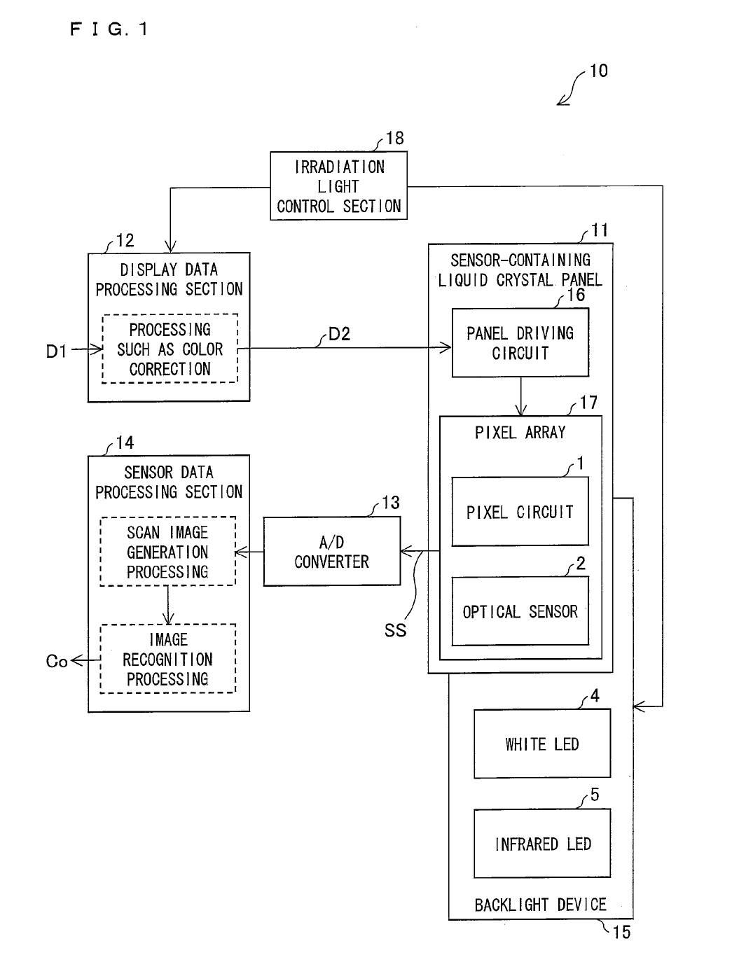

An embodiment of the present invention will be described below with reference to FIGS. 1 through 17.

(Configuration of Liquid Crystal Display Device 10)

FIG. 1 is a block diagram illustrating an arrangement of a liquid crystal display device 10 in accordance with an embodiment of the present invention. The liquid crystal display device 10 of FIG. 1 includes: a sensor-containing liquid crystal panel 11; a display data processing section 12; an A/D converter 13; an image sensing processing section (sensor data processing section) 14; a backlight device 15; and an irradiation light control section 18. The sensor-containing liquid crystal panel 11 (hereinafter referred to as “liquid crystal panel 11) includes panel driving circuits 16 and a pixel array 17. The pixel array 17 includes (i) a plurality of pixel circuits 1 and (ii) a plurality of optical sensors 2, both of which are aligned two-dimensionally.

The liquid crystal display device 10 receives display data D1 supplied from the outside. The display data processing section 12 carries out processing such as color correction and frame rate conversion with respect to the display data D1 according to need, and then supplies resulting display data D2 to the liquid crystal panel 11. In response, the panel driving circuits 16 apply, to the pixel circuits 1, voltages corresponding to the display data D2. As such, the liquid crystal panel 11 displays an image on the basis of the display data D2.

The backlight device 15 irradiates a back surface of the liquid crystal panel 11 with light (backlight) on the basis of a power supply voltage supplied from a backlight device power supply circuit (not shown). The backlight device 15 includes: white LEDs (light emitting diodes) 4 which emit white light (visible light); and infrared LEDs 5 which emit infrared light. Note that the backlight device 15 can alternatively include (i) instead of the white LEDs 4, any other light emitters that emit visible light, and (ii) instead of the infrared LEDs 5, any other light emitters that emit infrared light. Note further that the backlight device 15 can alternatively include, instead of the infrared LEDs 5, any non-visible light emitters that emit non-visible light. For example, the backlight device 15 can include, instead of the white LEDs 4, (i) a combination of a red LED, a green LED, and a blue LED, or (ii) cold cathode fluorescent lamps (CCFLs).

The panel driving circuits 16 not only apply voltages to the pixel circuits 1, but also read from each of the optical sensors 2 a voltage to be applied so as to correspond to an amount of light received by the optical sensor 2. The optical sensors 2 supply output signals as sensor output signals SS to the outside of the liquid crystal panel 11. The A/D converter 13 converts the sensor output signals SS, which are analog signals, into digital signals. The image sensing processing section 14 generates a digital image (hereinafter referred to as “scan image”) on the basis of the digital signals supplied from the A/D converter 13. The scan image may contain an image of an object (for example, a printed material, a finger, or a pen; hereinafter referred to as “target object”) to be detected which object is present near a front surface of the liquid crystal panel 11. The image sensing processing section 14 carries out image recognition processing with respect to the scan image so as to detect a target object.

The irradiation light control section 18 changes a display state of the liquid crystal panel 11 so as to control a ratio between a transmittance of visible light and a transmittance of infrared light (non-visible light) over the liquid crystal panel 11. This mechanism will be described later in detail.

(Configuration of Liquid Crystal Panel 11)

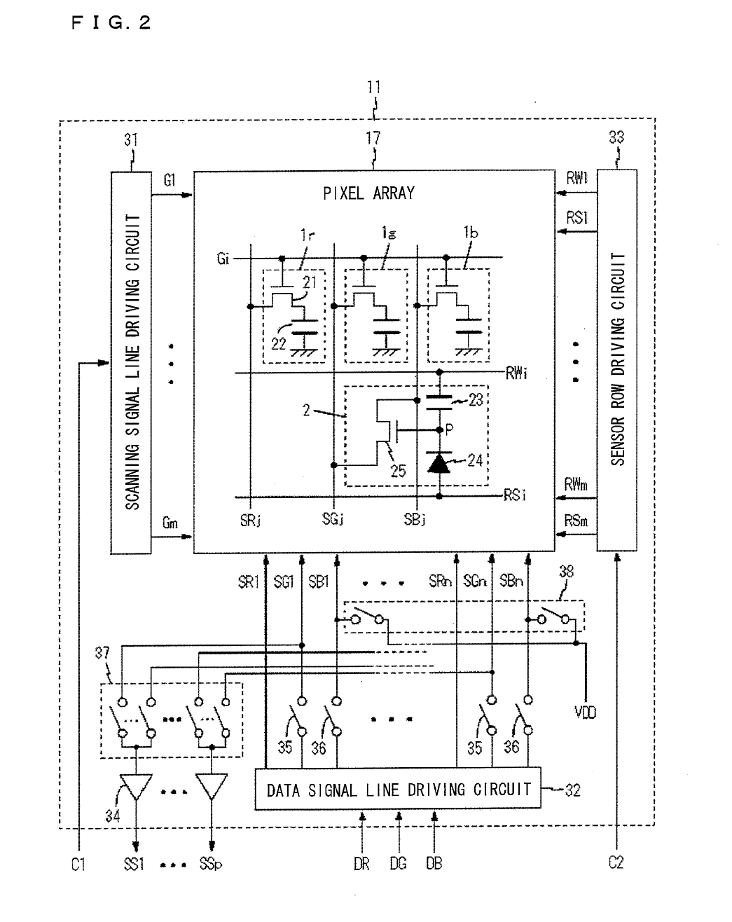

FIG. 2 is a block diagram illustrating a detailed arrangement of the liquid crystal panel 11. As illustrated in FIG. 2, the pixel array 17 includes: m scanning signal lines G1 through Gm; 3n data signal lines SR1 through SRn, SG1 through SGn, and SB1 through SBn; and m×3n pixel circuits 1. The pixel array 17 further includes: m×n optical sensors 2; m sensor read lines RW1 through RWm; and m sensor reset lines RS1 through RSm. The liquid crystal panel 11 still further includes polycrystalline silicon.

The scanning signal lines G1 through Gm are provided in parallel to one another. The data signal lines SR1 through SRn, SG1 through SGn, and SB1 through SBn are provided in parallel to one another so as to be orthogonal to the scanning signal lines G1 through Gm. The sensor read lines RW1 through RWm and the sensor reset lines RS1 through RSm are both provided in parallel to the scanning signal lines G1 through Gm.

The pixel circuits 1 are provided so that one of them is positioned in the vicinity of each of intersections of (i) the scanning signal lines G1 through Gm with (ii) the data signal lines SR1 through SRn, SG1 through SGn, and SB1 through SBn. The pixel circuits 1 are provided two-dimensionally as a group and in m rows (in a lateral direction in FIG. 2) and in 3n columns (in a longitudinal direction in FIG. 2). The pixel circuits 1 are divided into groups, depending on the colors of color filters to be used. The pixel circuits 1 are, for example, divided into the following three groups: R pixel circuits 1r, G pixel circuits 1g, and B pixel circuits 1b. The three kinds of pixel circuits are aligned in rows in an order of R, G, and B. Each three pixel circuits R, G, and B constitute a single pixel.

The pixel circuits 1 each include a TFT (thin film transistor) 21 and a liquid crystal capacitor 22. The TFT 21 has (i) a gate terminal connected to a scanning signal line G1 (where i is an integer which falls within a range from 1 to m), (ii) a source terminal connected to one of data signal lines SRj, SGj, and SBj (where j is an integer which falls within a range from 1 to n), and (iii) a drain terminal connected to one electrode of the liquid crystal capacitor 22. To the other electrode of the liquid crystal capacitor 22, a common electrode voltage is applied. In the description below, the data signal lines SG1 through SGn connected the respective G pixel circuits 1g are referred to as “G data signal lines,” and the data signal lines SB1 through SBn connected to the respective B pixel circuits 1b are referred to as “B data signal lines.” The pixel circuits 1 can each include a storage capacitor.

The pixel circuits 1 each have a light transmittance (that is, a luminance of each sub-pixel) which is determined by a voltage applied to the pixel circuit 1. In a case where a voltage is to be applied to a pixel circuit 1 which is connected to a scanning signal line G1 and a data signal line SXj (where X is one of R, G, and B), it is simply necessary to (i) apply a high-level voltage (a voltage which turns on a TFT 21) to the scanning signal line G1, and (ii) apply a voltage to be applied to the data signal line SXj. By applying to the pixel circuits 1 voltages corresponding to display data D2, it is possible to set each of the respective luminances of sub-pixels at a desired level.

(Configuration of Optical Sensor 2)

The optical sensors 2 each include a capacitor 23, a photodiode 24, and a sensor pre-amplifier 25, and are provided for respective pixels. The capacitor 23 has (i) one electrode connected to a cathode terminal of the photodiode 24 (the description below refers to a point of this connection as “nodal point P”), and (ii) the other electrode connected to a sensor read line RWi. The photodiode 24 has an anode terminal connected to a sensor reset line RSi. The sensor pre-amplifier 25 includes a TFT which has (i) a gate terminal connected to the nodal point P, (ii) a drain terminal connected to the B data signal line SBj, and (iii) a source terminal connected to the G data signal line SGj.

To detect an amount of light by the optical sensor 2, which is connected to lines such as the sensor read line RWi and the B data signal line SBj, it is simply necessary to (i) apply predetermined voltages to respective ones of the sensor read line RWi and the sensor reset line RSi, and (ii) apply a power supply voltage VDD to the B data signal line SBj. Specifically, the predetermined voltages are applied to the respective ones of the sensor read line RWi and the sensor reset line RSi. Then, in a case where the photodiode 24 receives light, a current corresponding to an amount of the light received flows through the photodiode 24, and a voltage at the nodal point P is lowered in accordance with the current which has flown through the photodiode 24. At this timing, a high voltage is applied to the sensor read line RWi so that (i) the voltage at the nodal point P is raised and (ii) a gate voltage of the sensor pre-amplifier 25 is thus raised to a threshold or higher. Next, the power supply voltage VDD is applied to the B data signal line SBj so that (i) the voltage at the nodal point P is amplified by the sensor pre-amplifier 25, and (ii) the voltage thus amplified is supplied to the G data signal line SGj. As such, it is possible to determine the amount of light, detected by the optical sensor 2, on the basis of the voltage supplied to the G data signal line SGj.

There are provided around the pixel array 17: a scanning signal line driving circuit 31; a data signal line driving circuit 32; a sensor row driving circuit 33; p sensor output amplifiers 34 (where p is an integer which falls within a range from 1 to n); and a plurality of switches 35 through 38. The scanning signal line driving circuit 31, the data signal line driving circuit 32, and the sensor row driving circuit 33 collectively correspond to the panel driving circuits 16 of FIG. 1.

The data signal line driving circuit 32 includes 3n output terminals for respective ones of the 3n data signal lines. One of the switches 35 is provided between (i) each of the G data signal lines SG1 through SGn and (ii) a corresponding one of n output terminals for the respective G data signal lines SG1 through SGn. One of the switches 36 is provided between (i) each of the B data signal lines SB1 through SBn and (ii) a corresponding one of n output terminals for the respective B data signal lines SB1 through SBn. The G data signal lines SG1 through SGn are divided into groups of p. One of the switches 37 is provided between (i) a k-th G data signal line (where k is an integer which falls within a range from 1 to p) within each group and (ii) an input terminal of a k-th sensor output amplifier 34. The B data signal lines SB1 through SBn are connected to respective first terminals of the switch 38. The power supply voltage VDD is applied to second terminals of the switch 38. The configuration of FIG. 2 includes n switches 35, n switches 36, n switches 37, and one switch 38.

In the liquid crystal display device 10, one frame period is divided into (i) a display period during which a signal (a voltage signal corresponding to display data) is applied to each pixel circuit and (ii) a sensing period during which a signal (a voltage signal corresponding to an amount of light received) is read from each optical sensor. The circuits illustrated in FIG. 2 operate differently between the display period and the sensing period. During the display period, the switches 35 and 36 are each set to an ON state, whereas the switches 37 and 38 are each set to an OFF state. During the sensing period, the switches 35 and 36 are each set to the OFF state, the switch 38 is set to the ON state, and the switches 37 are set to the ON state by time division so that the G data signal lines SG1 through SGn are connected to the respective input terminals of the sensor output amplifier 34 sequentially from one group to another.

During the display period, the scanning signal line driving circuit 31 and the data signal line driving circuit 32 operate. Specifically, the scanning signal line driving circuit 31, in accordance with a timing control signal C1, selects one of the scanning signal lines G1 through Gm for each line period, and thus applies (i) a high-level voltage to the scanning signal line thus selected and (ii) a low-level voltage to each of the remaining scanning signal lines. The data signal line driving circuit 32, on the basis of display data sets DR, DG, and DB supplied from the display data processing section 12, drives the data signal lines SR1 through SRn, SG1 through SGn, and SB1 through SBn by a line sequential method. More specifically, the data signal line driving circuit 32 (i) stores at least display data sets DR, DG, and DB representing one line, and thus (ii) for each line period applies, to the data signal lines SR1 through SRn, SG1 through SGn, and SB1 through SBn, respective voltages corresponding to the display data sets representing one line. The data signal line driving circuit 32 can alternatively drive the data signal lines SR1 through SRn, SG1 through SGn, and SB1 through SBn by a dot sequential method.

During the sensing period, the sensor row driving circuit 33 and the sensor output amplifiers 34 operate. Specifically, the sensor row driving circuit 33, in accordance with a timing control signal C2, selects one of the sensor read lines RW1 through RWm and a corresponding one of the sensor reset lines RS1 through RSm for each line period, and applies (i) a predetermined read voltage to the sensor read line thus selected, (ii) a predetermined reset voltage to the sensor reset line thus selected, (iii) a voltage to each of the remaining sensor read lines which voltage is different from the voltage applied to the sensor read line selected, and (iv) a voltage to each of the remaining sensor reset lines which voltage is different from the voltage applied to the sensor reset line selected. Note that a length of one line period is typically different between the display period and the sensing period. The sensor output amplifiers 34 amplify voltages selected by the switches 37, and output the voltages as sensor output signals SS1 through SSp.

(Timing Chart)

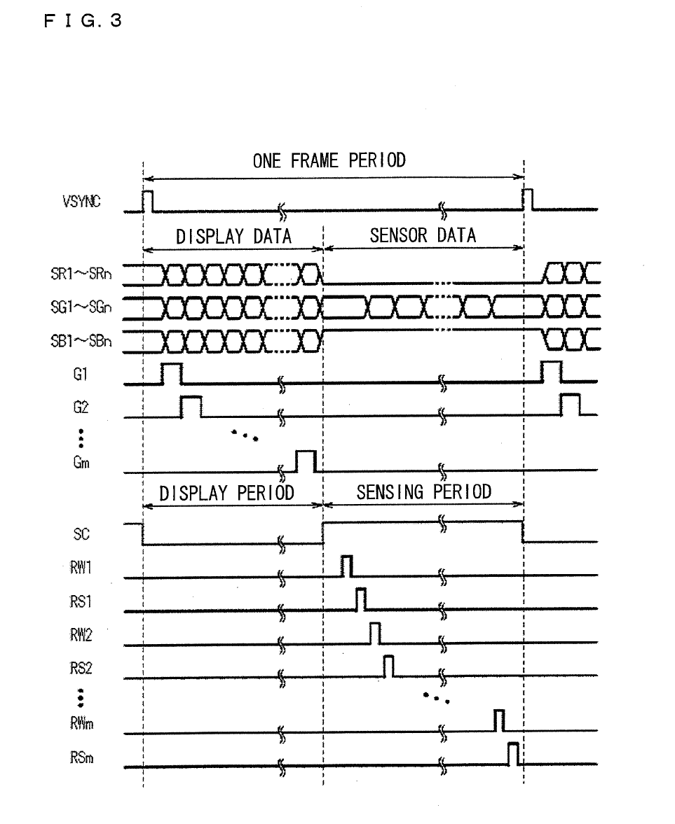

FIG. 3 is a timing chart for the liquid crystal display device 10. As illustrated in FIG. 3, a vertical synchronizing signal VSYNC becomes at a high level once for each frame period, and one frame period is divided into a display period and a sensing period. A sense signal SC is a signal indicative of either the display period or the sensing period, and is at a low level during a display period and at a high level during a sensing period.

During the display period, the switches 35 and 36 are set to the ON state so that the data signal lines SR1 through SRn, SG1 through SGn, and SB1 through SBn are all connected to the data signal line driving circuit 32. Specifically, during the display period, a voltage of the scanning signal line G1 becomes at a high level first, and a voltage of the scanning signal line G2 becomes at the high level next. Voltages of the respective scanning signal lines G3 through Gm sequentially become at the high level afterwards. While a voltage of the scanning signal line G1 is at the high level, voltages to be applied to respective ones of 3n pixel circuits 1 connected to the scanning signal line G1 are applied to respective ones of the data signal lines SR1 through SRn, SG1 through SGn, and SB1 through SBn.

During the sensing period, the switch 38 is set to the ON state, and the switches 37 are set to the ON state by time division. Thus, the power supply voltage VDD is constantly applied to the B data signal lines SB1 through SBn, and the G data signal lines SG1 through SGn are connected to the respective input terminals of the sensor output amplifier 34 by time division. Specifically, during the sensing period, a pair of the sensor read line RW1 and the sensor reset line RS1 is selected first, and a pair of the sensor read line RW2 and the sensor reset line RS2 is selected next. Pairs of respective ones of the sensor read line RW3 through RWm and respective ones of the sensor reset line RS3 through RSm are sequentially selected afterwards. A read voltage is applied to a selected sensor read line, and a reset voltage is applied to a selected sensor reset line. While the sensor read line RWi and the sensor reset line RSi are being selected, voltages each corresponding to the amount of light detected by one of n optical sensors 2 connected to the sensor read line RWi are supplied to respective ones of the G data signal lines SG1 through SGn.

(Location at which Backlight Device 15 is Provided)

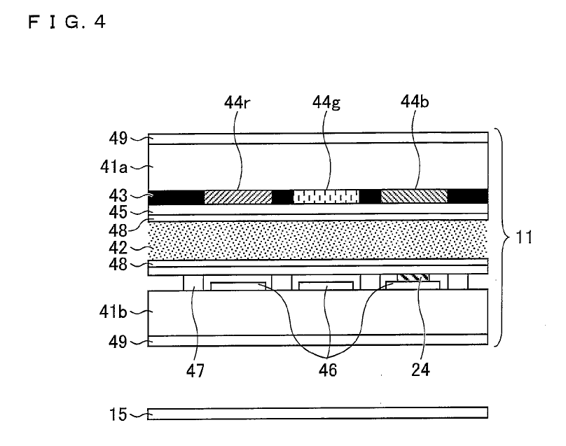

FIG. 4 is a view showing a cross section of the liquid crystal panel 11 and a location at which the backlight device 15 is provided. The liquid crystal panel 11 includes: two glass substrates 41a and 41b; and a liquid crystal layer 42 sandwiched between the glass substrates 41a and 41b. The glass substrate 41a is provided with members such as a light blocking film 43, color filters 44r, 44g, and 44b of three colors, and a counter electrode 45. The glass substrate 41b is provided with members such as pixel electrodes 46, data signal lines 47, and optical sensors 2. Each of the glass substrates 41a and 41b is further provided with (i) an alignment film 48 on a first surface thereof which faces the other of the glass substrates 41a and 41b and (ii) a polarizing plate 49 on a second surface thereof which is opposite to the first surface. The liquid crystal panel 11 has (i) a front surface on a first side of its two sides on which first side the glass substrate 41a is provided, and (ii) a back surface on a second side of the two sides on which second side the glass substrate 41b is provided. The backlight device 15 is provided so as to face the back surface of the liquid crystal panel 11. In an example illustrated in FIG. 4, a photodiode 24 included in an optical sensor 2 is provided in the vicinity of a pixel electrode 46 for which the blue color filter 44b is provided. Note that the photodiode 24 of such an optical sensor 2 can alternatively be provided in the vicinity of a pixel electrode 46 for which a color filter of a different color is provided, or in the vicinity of an opening formed in a color filter.

The following description deals in detail with the backlight device 15, which includes the infrared LEDs 5. The infrared LEDs 5, for example, emit infrared light having a wavelength shorter than a fundamental absorption edge wavelength (approximately 1100 nm) of silicon. By using such infrared LEDs, it is possible, in a case where the pixel circuits 1 and the optical sensors 2 each include polycrystalline silicon, to cause the optical sensors 2 to detect infrared light emitted from the infrared LEDs 5.

(Example Configurations of Backlight Device 15)

FIGS. 5 through 9 are views illustrating first through fifth example configurations of the backlight device 15, respectively. Backlight devices 15a through 15e illustrated in respective FIGS. 5 through 9 each include: one of light guide plates 64 and 74; two lens sheets 61 and 62 and a diffusing sheet 63 all provided on a first surface of the light guide plate; and one of reflecting sheets 65 and 72 provided on a second surface of the light guide plate.

The backlight devices 15a and 15b illustrated in respective FIGS. 5 and 6 each include: (i) a flexible printed circuit board 66 which is provided with respect to a side surface of the light guide plate 64 and on which white LEDs 4 are provided one-dimensionally; and (ii) an infrared light source provided so as to face the second surface of the light guide plate 64, on which second surface the reflecting sheet 65 is provided. The backlight device 15a includes, as the infrared light source, a circuit board 67 on which infrared LEDs 5 are provided two-dimensionally. The backlight device 15b includes an infrared light source including (i) a light guide plate 68, (ii) a flexible printed circuit board 69 (provided with respect to a side surface of the light guide plate 68) on which infrared LEDs 5 are provided one-dimensionally, and (iii) a reflecting sheet 70. The reflecting sheet 65 is a reflecting sheet which transmits infrared light and reflects visible light (for example, a reflecting sheet made of a polyester resin), whereas the reflecting sheet 70 is a reflecting sheet which reflects infrared light. In a case where an infrared light source is added, as described above, to a backlight device which emits visible light, it is possible to produce a backlight device 15, which emits both visible light and infrared light, by using a conventional backlight device as is.

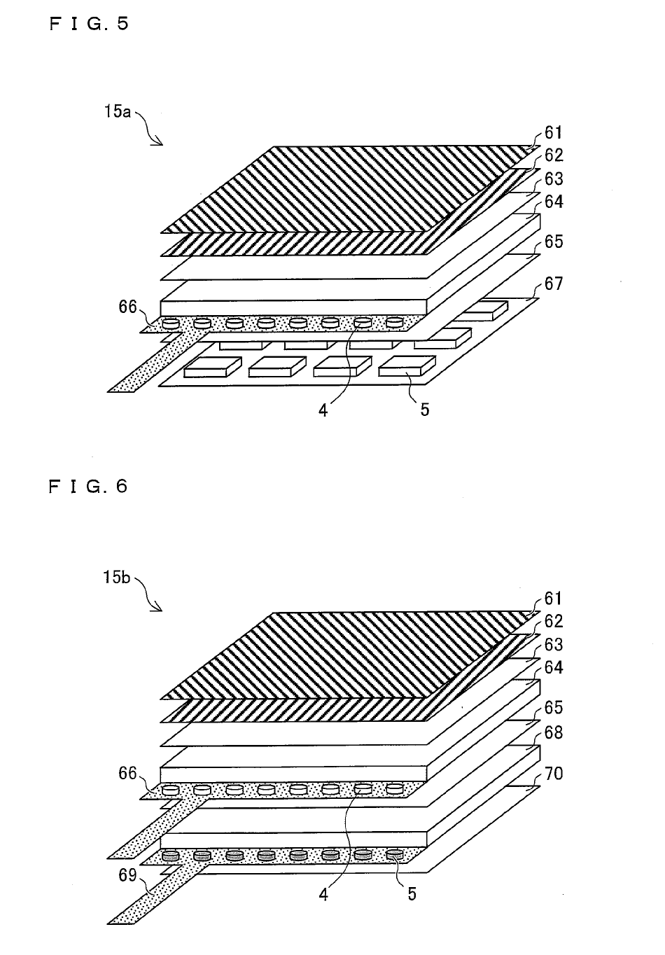

The backlight device 15c illustrated in FIG. 7 includes a flexible printed circuit board 71 which is provided with respect to a side surface of the light guide plate 64 and on which white LEDs 4 and infrared LEDs 5 are provided mixedly and one-dimensionally. The two kinds of LEDs are, for example, provided on the flexible printed circuit board 71 alternately. The reflecting sheet 72 is a reflecting sheet which reflects both visible light and infrared light. In a case where white LEDs 4 and infrared LEDs 5 are mixedly provided along a side surface of the light guide plate 64, it is possible to produce a backlight device 15 which emits both visible light and infrared light and which has a configuration identical to a configuration of a conventional backlight device.

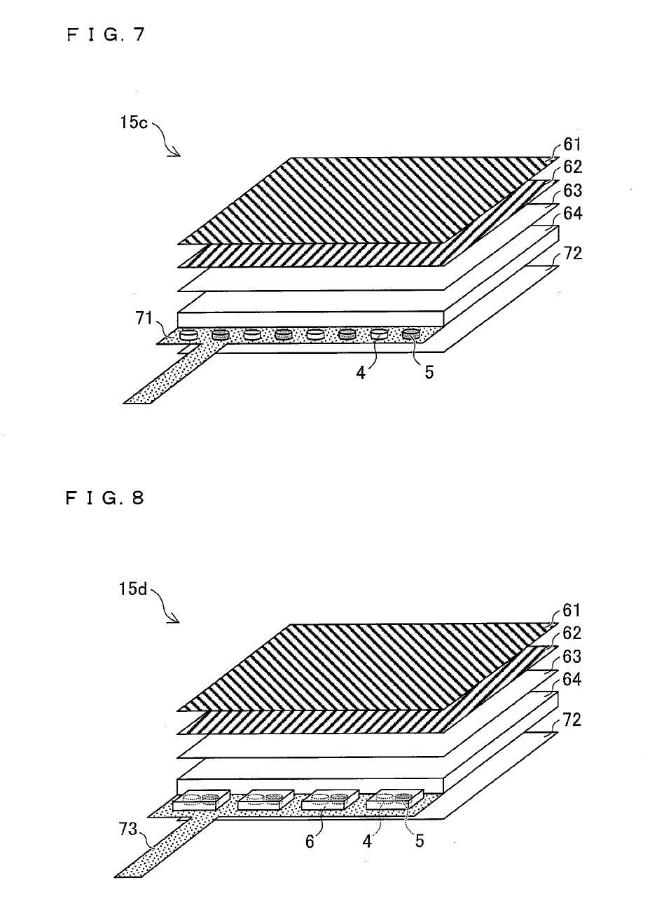

The backlight device 15d illustrated in FIG. 8 includes a flexible printed circuit board 73 which is provided with respect to a side surface of the light guide plate 64 and on which resin packages 6 each containing a white LED 4 and an infrared LED 5 are provided one-dimensionally. In a case where a white LED 4 and an infrared LED 5 are contained in a single resin package 6, it is possible to provide a large number of light emitters, that is, the LEDs, in a small space. Note that a single resin package 6 can either contain one white LED 4 and one infrared LED 5 or contain a plurality of white LEDs 4 and a plurality of infrared LEDs 5.

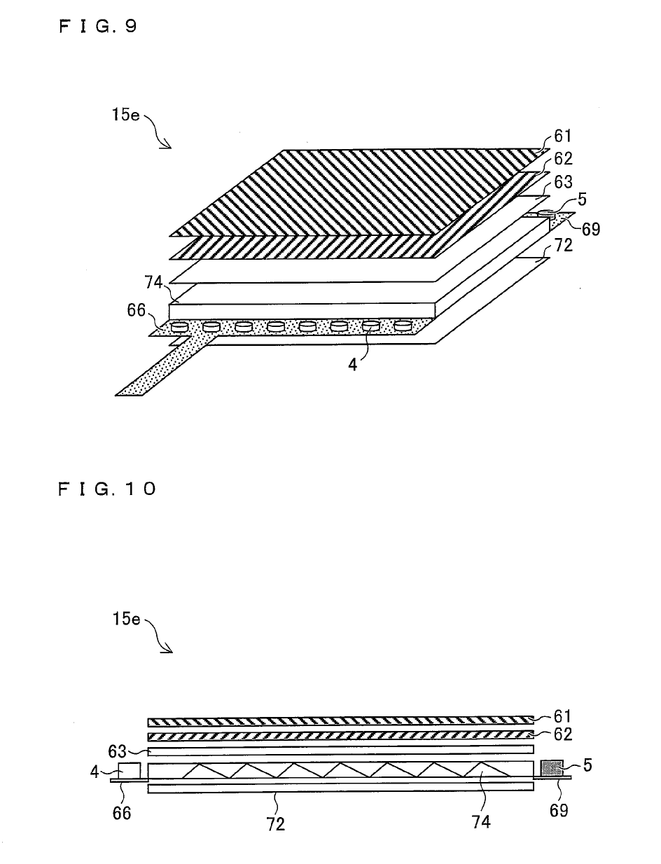

The backlight device 15e illustrated in FIG. 9 includes: a flexible printed circuit board 66 which is provided with respect to a first side surface of the light guide plate 74 and on which white LEDs 4 are provided one-dimensionally; and a flexible printed circuit board 69 which is provided with respect to a second side surface of the light guide plate 74, the second side surface being opposite to the first side surface thereof, and on which infrared LEDs 5 are provided one-dimensionally. FIG. 10 is a cross-sectional view illustrating the backlight device 15e. The light guide plate 74 is processed so as to allow propagation of both (i) white light which has entered the light guide plate 74 via the first side surface and (ii) infrared light which has entered the light guide plate 74 via the second side surface. In a case where, as described above, white LEDs 4 are provided with respect to one of two side surfaces of the light guide plate 74 and infrared LEDs 5 are provided with respect to the other of the two side surfaces, it is possible to produce a backlight device 15 which emits both visible light and infrared light while using, for two kinds of LEDs, a common light guide plate and other backlight device components.

(Light Transmittance of Liquid Crystal Panel 11)

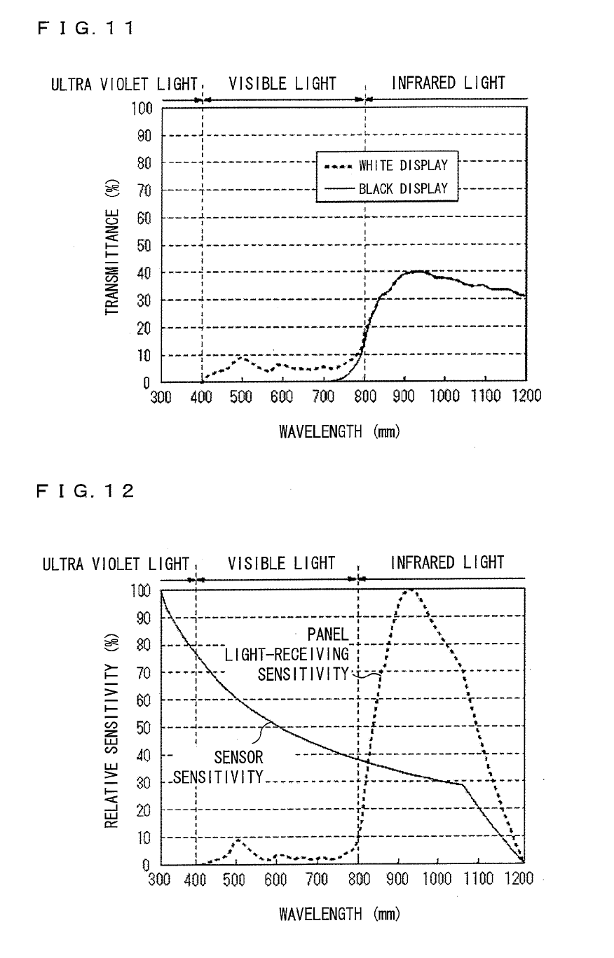

FIG. 11 is a graph showing a transmittance-spectral characteristic of the liquid crystal panel 11. FIG. 11 shows a light transmittance for a white display and a black display, which light transmittance includes a panel aperture ratio between the two polarizing plates 49. The light transmittance refers to a transmittance at which light that has entered one of the polarizing plates is emitted from the other of the polarizing plates. As shown in FIG. 11, the transmittance of the liquid crystal panel 11 is (i) approximately 40% at a maximum for infrared light and (ii) approximately 5% on average for visible light when a white display is being carried out. The transmittance of the liquid crystal panel 11 for infrared light reaches its maximum at a wavelength of 912 nm.

In a case where an optical sensor 2 is to detect a reflection of backlight (that is, light reflected by, for example, a finger), the backlight is first transmitted through the liquid crystal panel 11, and is then reflected by a finger so as to enter the optical sensor 2. A reflection of backlight of infrared light having the wavelength of 912 nm has an intensity which is approximately 32 times as high as an intensity of a reflection of backlight of visible light. (The intensity of “approximately 32 times as high” is determined as follows: {transmittance of light traveling from the backlight device to a finger}×{transmittance of light traveling from the finger to an optical sensor}={0.4/0.05}×{0.4/0.05×0.5}). Backlight of infrared light with such a suitable wavelength causes a reflection having an intensity which is significantly higher than that of a reflection caused by backlight of visible light.

FIG. 12 is a graph showing a sensitivity characteristic of the optical sensors 2 and a light-receiving sensitivity characteristic of the liquid crystal panel 11. FIG. 12 shows a sensitivity of the optical sensors 2 with its value being expressed as 100% for a wavelength of 300 nm. Since energy of light is directly proportional to its frequency (that is, inversely proportional to its wavelength), the sensitivity of the optical sensors 2 is inversely proportional to the wavelength as illustrated in FIG. 12. Note that the sensitivity of the optical sensors 2 decreases rapidly at wavelengths of 1050 nm and larger since absorptance of the polycrystalline silicon increases at such wavelengths.

FIG. 12 shows a broken line representative of the light-receiving sensitivity characteristic of the liquid crystal panel 11, which light-receiving sensitivity characteristic is determined on the basis of (i) the transmittance-spectral characteristic shown in FIG. 11 and (ii) the sensitivity of the optical sensors 2 shown in FIG. 12. Specifically, the light-receiving sensitivity characteristic is obtained by (i) multiplying, for each wavelength, the transmittance shown in FIG. 11 by the relative sensitivity, shown by a solid line in FIG. 12, and (ii) expressing the sensitivity with its value being 100% at the wavelength of 912 nm (at which the light-receiving sensitivity of the liquid crystal panel 11 is at its maximum). FIG. 12 indicates that the light-receiving sensitivity of the liquid crystal panel 11 for visible light is on average approximately 3.72% of the light-receiving sensitivity for light having the wavelength of 912 nm. This in turn indicates that the light-receiving sensitivity of the liquid crystal panel 11 is approximately 20 times higher for backlight of infrared light having the wavelength of 912 nm than for backlight of visible light. As such, the liquid crystal panel 11 has (i) a transmittance which is significantly higher for infrared light than for visible light and (ii) a light-receiving sensitivity which is higher for backlight of infrared light than for backlight of visible light.

(Example of Image Sensing by Liquid Crystal Display Device 10)

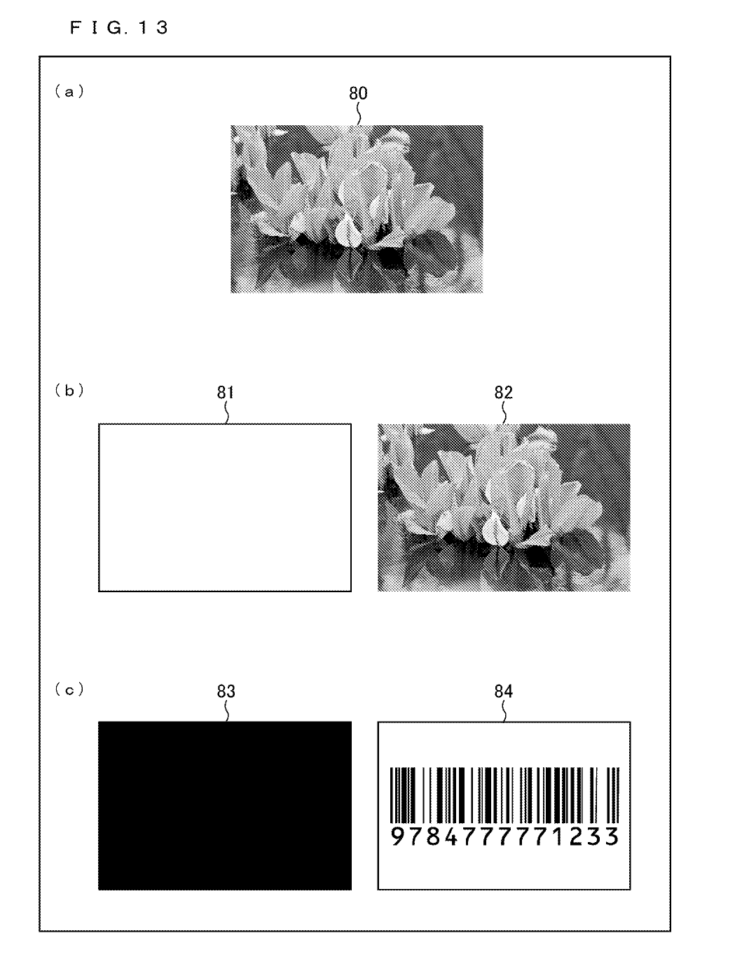

FIG. 13 illustrates a specific example of image sensing by the liquid crystal display device 10. (a) of FIG. 13 shows an image sensing object 80. The image sensing object 80 is a printed material which has on a surface (i) a photograph of a flower printed with an ink having a high reflectance for visible light and (ii) a bar code printed with an ink having a high reflectance for infrared light. Since the human eye cannot detect infrared light, a user can perceive, when directly seeing the image sensing object 80, only the photograph of the flower as in (a) of FIG. 13. Note that a similar image sensing effect can be achieved by printing involving use of inks which are different from each other in reflectance/absorptance for visible light and in reflectance/absorptance for infrared light.

The user causes the liquid crystal display device 10 to sense an image of the image sensing object 80 with use of at least one of visible light and infrared light.

The following description first exemplifies how the liquid crystal display device 10 senses an image of the image sensing object 80 with use of both visible light and infrared light. The liquid crystal display device 10 senses an image of the image sensing object 80 while causing the liquid crystal panel 11 to display a predetermined image which allows an image of the image sensing object 80 to be sensed with use of visible light. The description below assumes as an example that the predetermined image is a white image (see (b) of FIG. 13).

(b) of FIG. 13 exemplifies a case in which the liquid crystal display device 10 senses an image of the image sensing object 80 with use of both visible light and infrared light. Specifically, in the liquid crystal display device 10, the irradiation light control section 18 first instructs the display data processing section 12 to display a white image. In response to the instruction, the display data processing section 12 supplies, to the liquid crystal panel 11, display data D2 representative of a white image. Upon receipt of the display data D2, the liquid crystal panel 11 displays a white image 81 as illustrated in (b) of FIG. 13.

As shown in FIG. 11, the liquid crystal panel 11 has is transmissive for both visible light and infrared light when displaying a white image. As such, both visible light and infrared light emitted from the backlight device 15 reach the image sensing object 80, and are thus reflected from the image sensing object 80 toward the liquid crystal panel 11. The optical sensors 2 then receive such a reflection of the visible light and the infrared light. As a result, the image sensing processing section 14 completes the sensing of an image of the image sensing object 80.

The image sensing processing section 14 supplies, to the display data processing section 12, data of the sensed image as display data D1. The display data processing section 12 then carries out predetermined processing with respect to the display data D1 so as to convert the display data D1 into display data D2, and then supplies the display data D2 to the display data processing section 12. As a result, the liquid crystal panel 11 displays the image 82 as illustrated in (b) of FIG. 13. The image 82 is an image obtained by sensing an image of the image sensing object 80 with use of both visible light and infrared light. The image 82 includes both an image (visible light image) of the photograph of the flower and the image (infrared light image) of the bar code. However, since the image of the bar code is an image sensed with use of infrared light, the image of the bar code is less easily visible than the image of the photograph of the flower. Thus, as illustrated in (b) of FIG. 13, the human eye can see mainly the image of the photograph of the flower out of the two superimposed images. In other words, the image 82 looks substantially identical to the image sensing object 80 to the human eye.

As described above, the image sensing processing section 14 senses an image of the image sensing object 80 while a high-luminance image (preferably, a white image) is being displayed on the liquid crystal panel 11. While a high-luminance image (for example, an image having an average luminance exceeding 50% relative to a luminance of 100% for a white image) is being displayed, the liquid crystal panel 11 has a transmittance which is sufficiently high for both visible light and non-visible light. Thus, by sensing an image of the image sensing object 80 in such a display state, the image sensing processing section 14 can selectively obtain a visible light image of the image sensing object 80. In particular, in a case where the high-luminance image is a white image, the transmittance for visible light is closer to 100%. As such, a visible light image to be obtained will have a maximized sharpness.

The following description next exemplifies how the liquid crystal display device 10 senses an image of the image sensing object 80 with use of infrared light. The liquid crystal display device 10 senses an image of the image sensing object 80 while causing the liquid crystal panel 11 to display a predetermined image which allows an image of the image sensing object 80 to be sensed with use of infrared light. The description below assumes as an example that the predetermined image is a black image (see (c) of FIG. 13).

(c) of FIG. 13 exemplifies a case in which the liquid crystal display device 10 senses an image of the image sensing object 80 with use of infrared light. Specifically, in the liquid crystal display device 10, the irradiation light control section 18 first instructs the display data processing section 12 to display a black image. In response to the instruction, the display data processing section 12 supplies, to the liquid crystal panel 11, display data D2 representative of a black image. Upon receipt of the display data D2, the liquid crystal panel 11 displays a black image 83 as illustrated in (c) of FIG. 13.

As shown in FIG. 12, the liquid crystal panel 11 has, when displaying a black image, (i) almost no transmissivity for visible light and (ii) a sufficient transmissivity for infrared light. As such, only infrared light emitted from the backlight device 15 reaches the image sensing object 80, and is thus reflected from the image sensing object 80 toward the liquid crystal panel 11. The optical sensors 2 then receive such a reflection of the infrared light. As a result, the image sensing processing section 14 completes the sensing of an image of the image sensing object 80.

The image sensing processing section 14 supplies, to the display data processing section 12, data of the sensed image as display data D1. The display data processing section 12 then carries out predetermined processing with respect to the display data D1 so as to convert the display data D1 into display data D2, and then supplies the display data D2 to the display data processing section 12. As a result, the liquid crystal panel 11 displays a bar code image 84 as illustrated in (c) of FIG. 13. The bar code image 84 is an image obtained by sensing an image of the image sensing object 80 with use of infrared light. The user perceives the bar code, which is invisible in the case where the user directly sees the image sensing object 80, through the bar code image 84 displayed on the liquid crystal panel 11. In other words, the user can perceive the bar code hidden in the image sensing object 80 by causing the liquid crystal display device 10 to sense an image of the image sensing object 80.

As described above, the image sensing processing section 14 senses an image of the image sensing object 80 while a low-luminance image (preferably, a black image) is being displayed on the liquid crystal panel 11. While a low-luminance image (for example, an image having an average luminance of 50% or lower relative to a luminance of 100% for a white image) is being displayed, the liquid crystal panel 11 has a transmittance which is low for visible light and which is sufficiently high for non-visible light such as infrared light. Thus, by sensing an image of the image sensing object 80 in such a display state, the image sensing processing section 14 can selectively obtain a non-visible light image of the image sensing object 80. In particular, in a case where the low-luminance image is a black image, the transmittance for visible light is almost 0%. As such, a non-visible light image to be obtained will have a maximized sharpness.

The light-receiving sensitivity of the optical sensors 2, which light-receiving sensitivity is inversely proportional to the wavelength, has (i) a first theoretical value for an infrared light of 800 nm within an infrared light range and (ii) a second theoretical value for a visible light of 400 nm within a visible light range, the first theoretical value being half the second theoretical value. Thus, in a case where visible light and infrared light emitted from the backlight device 15 are equal to each other in energy, it is possible, by displaying an image with an average luminance of 50% or lower, to (i) reduce an influence of visible light and consequently (ii) further increase the sharpness of the infrared light image.

The irradiation light control section 18 can alternatively control the backlight device 15 so as to turn off the white LEDs 4, simultaneously with the instruction for the display data processing section 12 to display a black image. Specifically, the irradiation light control section 18 controls the backlight device 15 so as to turn off the white LEDs 4 by turning off a voltage supply to the white LEDs 4. Through this operation, the backlight device 15 is stopped from emitting visible light toward the liquid crystal panel 11, and only infrared light thus reliably reaches the image sensing object 80. It follows that there is almost no possibility that the bar code image 84 generated by sensing an image of the image sensing object 80 includes the image 82 (that is, an image obtained by sensing an image of the image sensing object 80 with use of visible light) as a noise.

As described above, the liquid crystal display device 10 can selectively sense a visible light image or an infrared light image from a single image sensing object 80 by controlling light to be emitted toward the image sensing object 80.

(Image Selection)

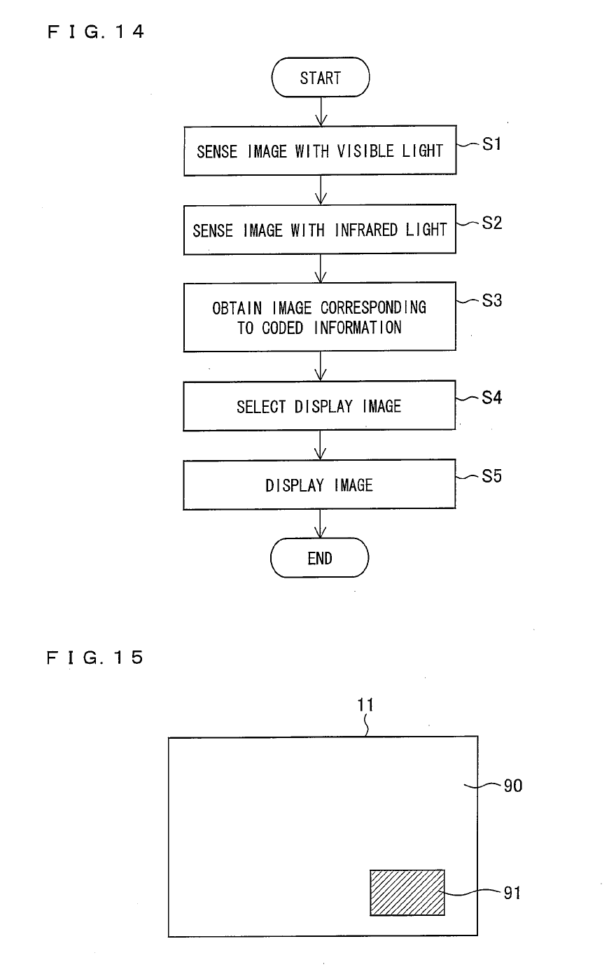

The liquid crystal display device 10 can cause the liquid crystal panel 11 to display not only (i) a visible light image obtained by sensing an image of an image sensing object 80, but also (ii) an image (related image) corresponding to information coded in an infrared light image obtained by sensing an image of the image sensing object 80. This processing will be exemplified below with reference to FIG. 14.

FIG. 14 is a flowchart illustrating the processing of a procedure for how the liquid crystal display device 10 senses an image of an image sensing object 80 and displays an image obtained.

First, the liquid crystal display device 10 senses an image of an image sensing object 80 with use of visible light (step S1), and thus obtains an image 82. Next, the liquid crystal display device 10 senses an image of the image sensing object 80 with use of infrared light (step S2), and thus obtains a bar code image 84, which includes predetermined coded information. The liquid crystal display device 10 then obtains, from a memory (not shown), an image corresponding to the coded information (step S3). After that, the liquid crystal display device 10 selects, as a display image, one of the image 82 and the image obtained from the memory (step S4). Finally, the liquid crystal display device 10 causes the liquid crystal panel 11 to display the image thus selected (step S5).

The processing of FIG. 14 has, for instance, the following advantage: Assuming that the liquid crystal panel 11 includes a single optical sensor 2 for each pixel, the liquid crystal display device 10 cannot sense a color image of an image sensing object 80. Thus, by simply sensing an image of the image sensing object 80, the liquid crystal display device 10 can obtain only a monochrome image 82. In view of this, information indicative of a color version of the image 82 is coded in a bar code embedded in the image sensing object 80. Note that the liquid crystal display device 10 includes a memory in which a color image 82 is stored in advance. The liquid crystal display device 10 senses an image of the image sensing object 80 with use of infrared light so as to obtain a bar code image 84. The liquid crystal display device 10 then (i) obtains, from the memory, the color image corresponding to the information coded in the bar code image 84, and (ii) causes the liquid crystal panel 11 to display the color image. With this arrangement, the user feels as if the liquid crystal display device 10 has sensed a color image of the image sensing object 80. In other words, the liquid crystal display device 10, even if it is only capable of sensing a monochrome image, can allow the user to have a feel of the ability to capture a color image.

The liquid crystal display device 10 can alternatively correct an image 82 for display on the basis of information coded in a bar code image 84 obtained by sensing an image of the image sensing object 80. The liquid crystal display device 10 can, for example, (i) change a color of the image 82, (ii) add to the image 82 characters, graphics and the like which are not printed in the image sensing object 80, or (iii) in a case where the image 82 includes an image of a person, add a line of speech for the person. As a result, it is possible to obtain, from the image 82 (visible light image), a visual effect which cannot be achieved in a case where the user sees the image sensing object 80.

(Setting of Image Sensing Region)

FIG. 15 is a view illustrating a state of the liquid crystal panel 11 in which state an infrared light image sensing region 91 has been set. The infrared light image sensing region 91 has been set in a part of a display region 90 of the liquid crystal panel 11. Specifically, the part of the display region 90 displays a black image as the infrared light image sensing region 91. A remaining region of the display region 90 is a region for displaying a predetermined image. The remaining region can display, for example, a white image or a moving image. By setting an infrared light image sensing region 91 in a part of the display region 90 as described above, the liquid crystal display device 10 can sense an infrared light image with use of a part of a display surface of the liquid crystal panel 11.

In a case where an image sensing object 80 is provided with a decoration (for example, a print) which does not reflect visible light but does reflect infrared light, the liquid crystal display device 10 can selectively obtain, when sensing an image of a single image sensing object 80, a visible image 82 or an invisible bar code image 84 from the image sensing object 80 by controlling a light transmittance of the liquid crystal panel 11 as described above. The light transmittance of the liquid crystal panel 11 can be flexibly changed by changing a property (for example, a color and a pattern) of an image to be displayed on the liquid crystal panel 11. Further, by partially changing a display state of the liquid crystal panel 11, it is possible to, for example, emit infrared light from only a part of the liquid crystal panel 11 toward the image sensing object 80. It follows that the liquid crystal display device 10 can sense an infrared light image with use of only a part of an image sensing surface of the liquid crystal panel 11.

(Displaying of Guide Frame 92)

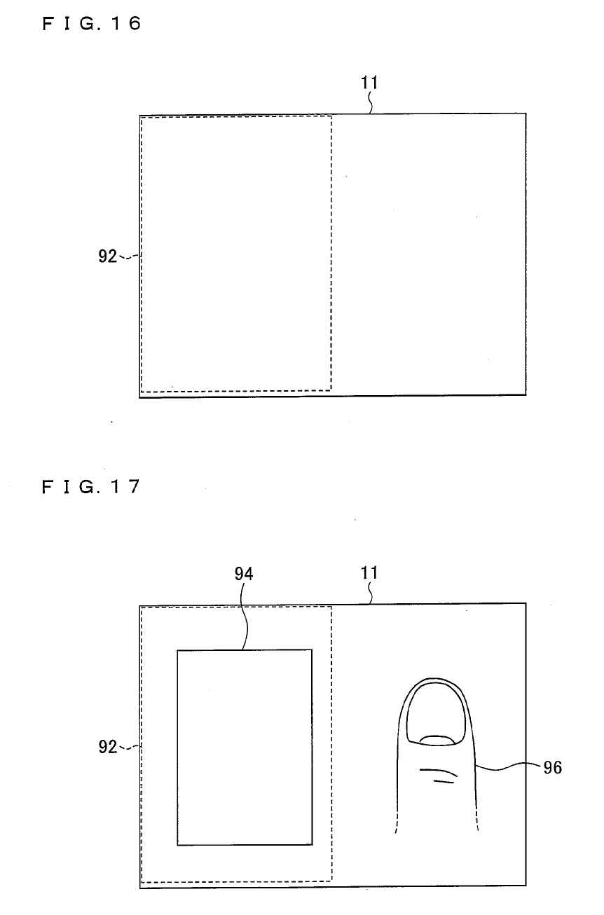

The liquid crystal display device 10 can, with use of an additional arrangement illustrated in FIG. 16, have a greater accuracy in sensing an infrared light image. FIG. 16 is a view illustrating the liquid crystal panel 11 on which a guide frame 92 displayed. The guide frame 92 is displayed at a predetermined location on the liquid crystal panel 11 of the liquid crystal display device 10 of FIG. 16. The guide frame 92 displayed on the liquid crystal panel 11 defines a region for sensing an infrared light image. Specifically, the liquid crystal display device 10 first displays, for example, a black image in the region defined by the guide frame 92, and then senses an image of an image sensing object 80.

The user, when seeing an infrared light image of an image sensing object 80, first checks that the guide frame 92 is displayed on the liquid crystal panel 11, and then places the image sensing object 80 close to the region defined by the guide frame 92. The user makes certain during this step that the image sensing object 80 is placed within the region defined by the guide frame 92. As a result, with the liquid crystal display device 10 having the above arrangement, it is possible to sense an infrared light image of the image sensing object 80 more accurately than in a case where the liquid crystal display device 10 does not include the guide frame 92.

(Authentication Processing)

The liquid crystal display device 10 can provide a greater security for authentication by carrying out authentication processing illustrated in FIG. 17. FIG. 17 is a view illustrating how the liquid crystal display device 10 of FIG. 1 carries out authentication processing. As in the liquid crystal panel 11 of FIG. 16, the guide frame 92 displayed on the liquid crystal panel 11 of FIG. 17 defines a region which is an infrared light image sensing region 91 for sensing an infrared light image. The other region on the liquid crystal panel 11 is a visible light image sensing region for sensing a visible light image.

For the authentication processing by the liquid crystal display device 10, the user places a predetermined printed material 94 for authentication in the infrared light image sensing region 91 of the liquid crystal panel 11. The printed material 94 for authentication has a code of predetermined information for authentication (for example, a code such as a bar code and a QR code [registered trademark], an ID, and/or a password) which code is printed with an ink having a high reflectance for infrared light. The liquid crystal display device 10 reads the coded information by emitting infrared light toward the printed material 94 for authentication so as to sense its image. Then, an authentication processing section (second determining section; not shown) of the liquid crystal display device 10 determines whether an authentication processing based on the coded information read as above has been successfully completed.

Next, the user places a finger 96 of their own close to the visible light image sensing region of the liquid crystal panel 11. The liquid crystal display device 10 senses a visible light image of the finger 96 so as to obtain an image of a fingerprint of the finger 96. An authentication processing section (first determining section; not shown) of the liquid crystal display device 10 then determines whether an authentication processing based on the fingerprint image thus obtained has been successfully completed.

An authentication processing section determines, if both of the above two authentication processings have been successfully completed, that user authentication by the liquid crystal display device 10 has been successfully completed. This indicates that if only one of the two authentication processings has been successfully completed, the liquid crystal display device 10 will not provide authentication for the user. With the arrangement, the liquid crystal display device 10 can have a greater security for user authentication.

The liquid crystal display device 10 can alternatively sense, on an identical screen of the liquid crystal panel 11, an image of the printed material 94 for authentication and an image of the finger 96 separately from each other at different times.

The present invention is not limited to the description of the embodiments above, but may be altered in various ways by a skilled person within the scope of the claims. A new embodiment based on a combination of technical means appropriately altered within the scope of the claims is also encompassed in the technical scope of the present invention.

For example, the above-mentioned bar code image 84 is merely an example of the image which can be sensed with use of non-visible light. Further, the above-mentioned infrared light is merely an example of non-visible light as well. The non-visible light as used herein refers to any light having a wavelength (within a wavelength band) which is outside a wavelength range of visible light. The non-visible light thus has a technical scope which includes, for example, infrared light, far infrared light, near visible light, ultra violet light, and X rays. The liquid crystal display device 10 can be arranged to be capable of emitting any of the above kinds of non-visible light toward an image sensing object 80, and can thus sense an image of the image sensing object 80 with use of such non-visible light so as to obtain a non-visible light image.

The display device of the present invention can be in the form of not only the liquid crystal display device 10 of the present embodiment, but also various other display devices such as a plasma display and an organic EL display.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided that such variations do not exceed the scope of the patent claims set forth below.

### INDUSTRIAL APPLICABILITY

The present invention is widely applicable as various display devices, such as a portable display device, which have an image sensing function. The present invention particularly has a potential application as a portable terminal device which has both a display function and an image sensing function. More particularly, the present invention is remarkably suitable for use as a mobile telephone and a portable game device.

### REFERENCE SIGNS LIST

1 pixel circuit
2 optical sensor
4 white LED (visible light emitter)
5 infrared LED (non-visible light emitter)
6 resin package
10 liquid crystal display device (display device)
11 sensor-containing liquid crystal panel (display panel)
12 display data processing section (related image display section; guide frame display section)
13 A/D converter
14 image sensing processing section
15 backlight device (light source)
16 panel driving circuit
17 pixel array
18 irradiation light control section (irradiation light control section/light emitter control section)
24 photodiode
41 glass substrate
42 liquid crystal layer
43 light blocking film
44 color filter
64, 68, 74 light guide plate
65, 70, 72 reflecting sheet
80 image sensing object
81 white image
82 image
83 black image
84 bar code image
90 display region
91 infrared light image sensing region
92 guide frame
94 printed material for authentication
96 finger

1. A display device having a function of sensing an image of an image sensing object,
the display device comprising:
a display panel which transmits light that has entered the display panel and which has a transmittance variable for the light;
a light source which emits, to the display panel, light including visible light and non-visible light; and
an optical sensor which is provided in the display panel and which receives at least non-visible light that enters the display panel,
the display device adjusting a ratio between the visible light and the non-visible light, both of which are emitted to an image sensing object, so as to sense an image of the image sensing object with use of at least the non-visible light.

2. The display device according to claim 1,
further comprising:
an irradiation light control section which controls the ratio by changing a display state of the display panel.

3. The display device according to claim 2,
further comprising:
an image sensing processing section which causes the optical sensor to sense the image of the image sensing object while causing the display panel to display a predetermined image.

4. The display device according to claim 3,
wherein:
the image sensing processing section causes the optical sensor to sense the image of the image sensing object while causing the display panel to display a low-luminance image.

5. The display device according to claim 4,
wherein:
the low-luminance image is a black image.

6. The display device according to claim 3,
wherein:
the image sensing processing section causes the optical sensor to sense the image of the image sensing object while causing the display panel to display a high-luminance image.

7. The display device according to claim 6,
wherein:
the high-luminance image is a white image.

8. The display device according to claim 3,
further comprising:
a related image display section which, in a case where the image sensing processing section senses the image of the image sensing object with use of non-visible light reflected from the image sensing object, causes the display panel to display a predetermined related image corresponding to information coded in the image of the image sensing object.

9. The display device according to claim 3,
further comprising:
a guide frame display section which causes the display panel to display a predetermined guide frame in a region around a location at which the predetermined image is displayed.

10. The display device according to claim 3,
further comprising:
a first determining section which, in a case where the image sensing processing section has sensed an image of a finger of a user with use of visible light reflected from the finger, determines whether first authentication based on the image of the finger has been successfully completed;
a second determining section which, in a case where the image sensing processing section has sensed the image of the image sensing object with use of non-visible light reflected from the image sensing object, determines whether second authentication based on information coded in the image of the image sensing object has been successfully completed; and
an authentication processing section which authenticates the user if (i) the first determining section has determined that the first authentication has been successfully completed and (ii) the second determining section has determined that the second authentication has been successfully completed.

11. The display device according to claim 1,
wherein:
the light source includes (i) a visible light emitter which emits visible light and (ii) a non-visible light emitter which emits non-visible light; and
the display device further comprises a light emitter control section which controls light emission of the visible light emitter and light emission of the non-visible light emitter.

12. The display device according to claim 1,
wherein:
the non-visible light is infrared light.

13. The display device according to claim 1, wherein the display device is a liquid crystal display device.
